(19) United States
(12) Patent Application Publication
(10) Pub. No.: US 2011/0307625 A1
(43) Pub. Date: Dec. 15, 2011

(54) INDEX-BASED VIDEO PLAY APPARATUS AND METHOD USING DOUBLE BUFFERING

(75) Inventor: Choon Won PARK, Incheon-si (KR)

(73) Assignee: WizMeta Co., Ltd., Incheon-si (KR)

(21) Appl. No.: 13/094,084

(22) Filed: Apr. 26, 2011

(30) Foreign Application Priority Data
Jun. 9, 2010 (KR) 10-2010-0054393

(51) Int. Cl. G06F 15/16

(52) U.S. Cl. 709/231

(57) ABSTRACT

Provided is an index-based video play apparatus and method. The apparatus includes a plurality of queuing units, a plurality of buffering units, and a control switching unit. The plurality of queuing units classify and store pieces of video-related information transmitted from one or more video service servers. The plurality of buffering units include a front buffer for buffering a current video data being played and a back buffer for buffering a next video data waiting in the queuing unit to be played. The control switching unit creates an ordered pair for the video data provided from the front buffer to transmit to the user's terminal. Here, the number of the queuing units and the buffering units is a largest number among numbers of videos that are obtained by excluding duplication of the videos in order.

### CROSS-REFERENCE TO RELATED APPLICATIONS

This U.S. non-provisional patent application claims priority under 35 U.S.C. §119 of Korean Patent Application No. 10-2010-0054393, filed on Jun. 9, 2010, the entire contents of which are hereby incorporated by reference in their entirety.

### BACKGROUND

The present disclosure herein relates to an index-based video play apparatus and method, and more particularly, to an index-based video play apparatus and method using double buffering scheme, which can combine and play video data transmitted from different Web sites through different streaming methods.

With the development of the Internet technology, video file downloading or streaming services from video service servers to an on-line desktop PC or a mobile phone using wireless Internet is becoming common.

In a typical real-time video service, when a request for a specific video file is received from a user's terminal, a video service server extracts a corresponding video file stored in a video server and streams the video file to the user's terminal.

Examples of streaming methods applied to such a case include a bit rate throttling (BRT) method and an adaptive streaming method.

The BRT method refers to a method for minimizing an economic loss caused by excessive pre-buffering upon discontinuous play, by buffering only up to about 10 seconds prior to playing.

On the other hand, the adaptive streaming method refers to a method of mimicking streaming using standard web technology such as Hypertext transfer protocol (HTTP) instead of a typical streaming technology. The adaptive streaming method slices video data into pieces like sliced cheese and transmits them through standard HTTP technology. Accordingly, this method enables an optimized video service by changing the quality of transmitted video data in response to the fluctuation of the line quality of, e.g., Internet.

However, such a typical real-time streaming video service has various disadvantages that discourage the user from using the service. For example, even when only a part of a long video file is needed, the whole of the video file has to be viewed. When required contents are distributed across different video files, the required contents have to be extracted, re-edited, and re-encoded from each video files using a professional video processing program. Also, when required video files exist in different sites, the corresponding sites have to be individually accessed.

The disadvantages of such a typical video service can be overcome by developing a video service environment and a video player with the so-called video duration time marking (VDTM) scheme. In VDTM scheme, just like a page that needs to be revisited is bookmarked while Internet surfing, the video parts that may be reused among required parts of a plurality of videos distributed across different sites are marked with video duration time stamps and such VDTM information is stored in a database. Only the VDTM is needed to be retrieved and combined to play the necessary parts of the video.

Technical challenges that should be solved in a video player to be developed for a new service, as described above, are interruption in playing video or inability to play video that may occur when videos provided from different video service sites providing different streaming services through different streaming methods are combined and played in real-time. In other words, a typical video play method processes only a single type of stream data according to a policy adopted by a corresponding site. Also, a website rarely supports both the BRT method and adaptive streaming method at the same time. Thus, when a series of videos including different streaming types are played, a video play apparatus that enables data play transmitted based on a complex streaming technique is required.

### SUMMARY

The present disclosure provides a video play apparatus and method that allows different videos provided from different video service sites to be played in various devices by extracting required parts from the videos and connecting them without a separate editing, and allows different videos to which different types of streaming technologies are applied to be smoothly played.

Embodiments of the present invention provide index-based video play apparatuses for playing videos using double buffering scheme by combining pieces of video-related information transmitted from one or more video service servers in a video service information combination server and transmitting the combined video-related information to a user's terminal, the apparatus including: a plurality of queuing units classifying and storing the combined video-related information transmitted from the video service servers; a plurality of buffering units including a front buffer for buffering a current video data being played and a back buffer for buffering a next video data waiting in the queuing unit to be played; and a control switching unit creating an ordered pair for the video data provided from the front buffer to transmit to the user's terminal, wherein the number of the queuing units and the buffering units is a largest number among numbers of videos that are obtained by excluding duplication of the videos in order.

In other embodiments of the present invention, index-based video play methods for playing videos using double buffering scheme by combining pieces of video-related information transmitted from one or more video service servers in a video service information combination server and transmitting the combined video-related information to a user's terminal, the method including: classifying and storing, by a queuing unit of the video service information combination server, the combined video-related information transmitted from the video service servers; buffering, by a front buffer of a buffering unit of the service information combination server, a current video data being played; buffering, by a back buffer of the buffering unit of the service information combination server, a next video data waiting in the queuing unit to be played; and creating, a control switching unit of the service information combination server, an ordered pair for the video data provided from the front buffer to transmit to the user's terminal, wherein the number of the queuing units and the buffering units is a largest number among numbers of videos that are obtained by excluding duplication of the videos in order.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a schematic diagram illustrating a network including an index-based video play apparatus using double buffering scheme according to an embodiment of the present invention;

FIG. 2 is a block diagram illustrating a configuration of an index-based video play apparatus using double buffering scheme according to an embodiment of the present invention;

FIG. 3 is a schematic diagram illustrating an operation of an index-based video play apparatus using double buffering scheme according to an embodiment of the present invention;

FIGS. 4A and 4B are schematic diagrams illustrating an operation of a control switching unit of a video play apparatus according to an embodiment of the present invention; and

FIG. 5 is a flowchart illustrating an index-based video play method using double buffering scheme according to an embodiment of the present invention.

### DETAILED DESCRIPTION OF THE EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, exemplary embodiments of the present invention will be described in detail with reference to the accompanying drawings.

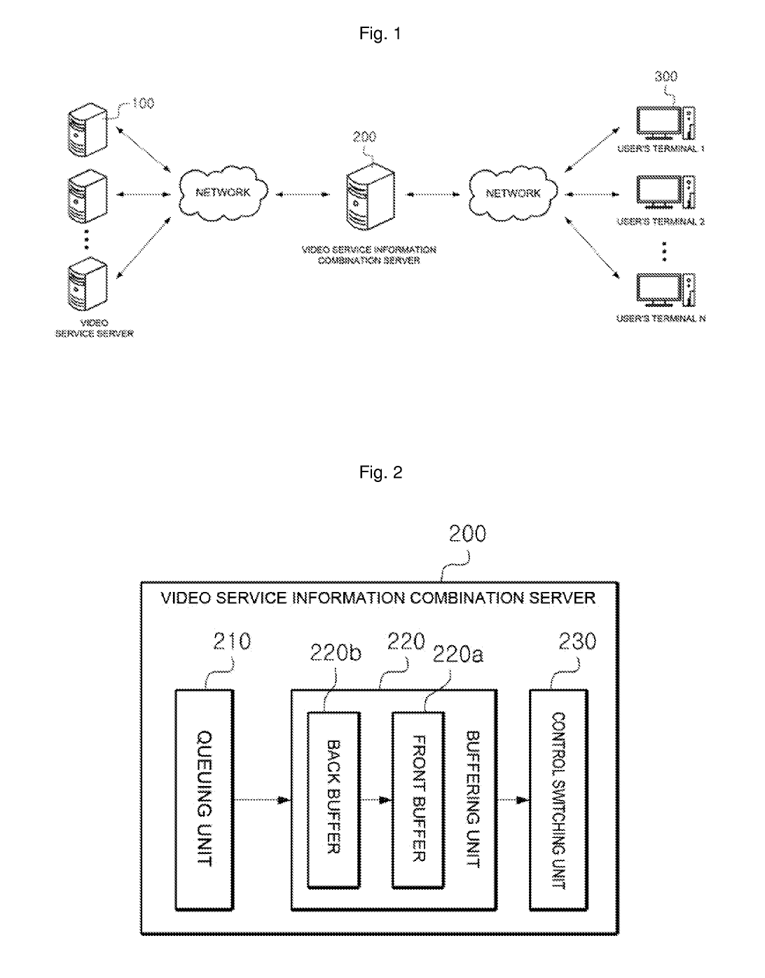

FIG. 1 is a schematic diagram illustrating a network including an index-based video play apparatus using double buffering scheme according to an embodiment of the present invention. Referring to FIG. 1, various pieces of video-related information transmitted from one or more video service servers 100 are combined together in a video service information combination server 200, and then are transmitted to a user terminal 300 for play.

As described above, since video data is transmitted from different video service servers through different transmission methods, it is difficult to play video data received from different video server through different streaming methods in one player.

Accordingly, the present invention provides a new service, which has not been available in a typical single-streaming method, by introducing the video service information combination server 200 and developing a double buffering method.

FIG. 2 is a block diagram illustrating a configuration of an index-based video play apparatus using double buffering scheme according to an embodiment of the present invention. Referring to FIG. 2, the index-based video play apparatus using the double buffering scheme may include a plurality of queuing units 210 for classifying and storing information related to videos transmitted from the video service servers 100, a plurality of buffering units 220 including a front buffer 220a for buffering a current video data being played and a back buffer 220b for buffering a next video data waiting in the queuing unit 210 to be played, and a control switching unit 230 for creating ordered pairs about the video data provided from the front buffer 220a to transmit them to the users terminal 300.

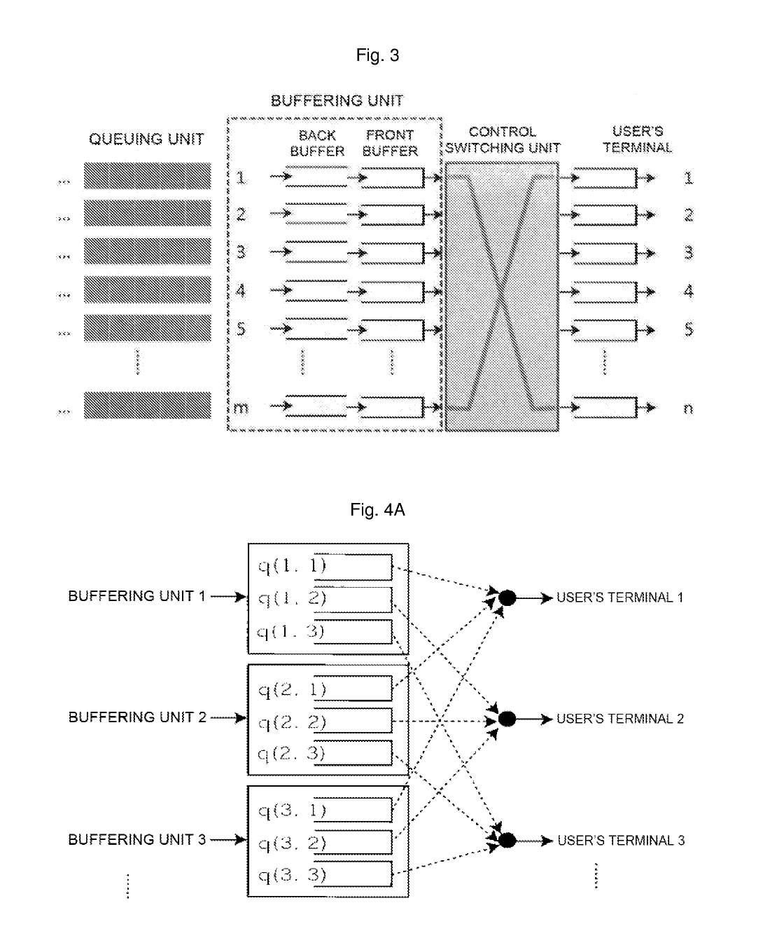

FIG. 3 is a schematic diagram illustrating an operation of an index-based video play apparatus using double buffering scheme according to an embodiment of the present invention. Referring to FIG. 3, m queuing units 210 and buffering units 220 are provided. Here, m is determined to be the largest number among numbers of videos to be played in the user terminal 300 that are obtained by excluding duplication of the videos in order.

The present invention adopts double buffering scheme to play videos. Due to a difference between the loading time of a non-buffered video by an adapted streaming method and the loading time of a buffered video by bit rate throttling streaming method, a new video may be delivered even though a previous video has not been completely played. The present invention is for preventing interruption in playing the videos.

As shown in FIG. 3, the buffering unit 220 includes the plurality of front buffers 220a and the plurality of back buffers 220b. The front buffer 220a is a buffer from which the video play apparatus is currently reading. The back buffer 220b, although not shown in the current screen, is a buffer on which a job processor in the queuing unit 210 is writing. In order to prevent interruption in playing videos, the back buffer 220b is continuously written with a next video to be played while the contents of the front buffer 220a are played. As a result, the buffering unit is repeatedly switched between a front buffer and a back buffer. In other words, if the writing on the current back buffer is completed, the back buffer serves as a front buffer, and the previous front buffer serves as a back buffer.

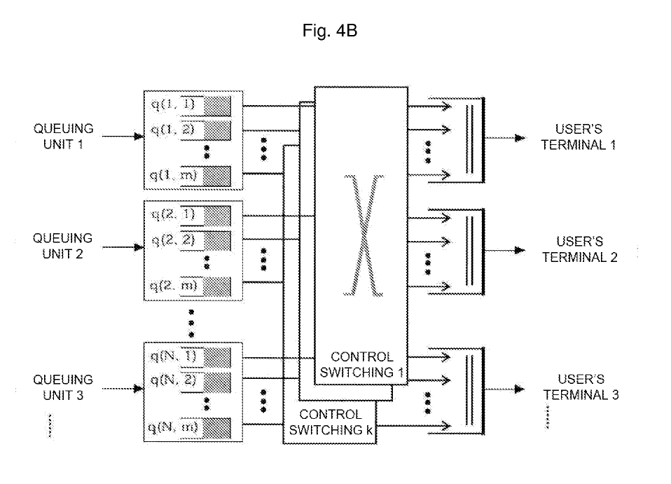

FIGS. 4A and 4B are schematic diagrams illustrating an operation of a control switching unit of a video play apparatus according to an embodiment of the present invention. Referring to FIGS. 4A and 4B, the control switching unit 230 creates ordered pairs for video data from the buffering units 220, and transmits the ordered pairs to corresponding user's terminals 300. In this case, the control switching unit 230 creates a pair of videos to be directly played and at the same time an ordered pair of next videos to be played, using multi-thread. FIG. 4A shows that a pair of videos to be directly played are created, and FIG. 4B shows that a pair of next videos to be played are created. Ordered pairs are created using N, the number of user's terminals 300, and M, the number of queuing units 210 and buffering units 220. Video data corresponding to the ordered pairs are transmitted to the respective user's terminals 300. In this case, video data communication between the video service information combination server 200 and the user's terminals 300 may be performed through a typical Internet communication protocol such as HTTP or a wireless application protocol.

As a result, the user's terminal 300 may easily play different videos transmitted from different video service servers 100 through different streaming methods, using one play program.

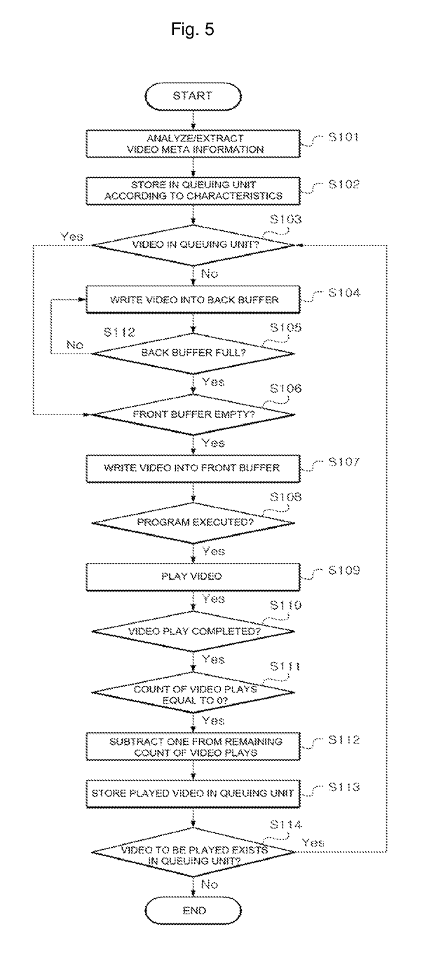

FIG. 5 is a flowchart illustrating an index-based video play method using double buffering scheme according to an embodiment of the present invention.

In operation 5102, video meta information transmitted from the video service servers 100 is analyzed and extracted in the queuing unit 210 of the video service information combination server 200, and then, in operation 5102, is stored in the queuing unit 210 according to the characteristics thereof.

In operation S103, it is determined whether a video exists in the queuing unit 210. If not, the video is written in the back buffer 220b in operation S104. In operation S105, a service program determines whether the back buffer 220b is full, with reference to a value set in the server. If the back buffer 220b is full, in operation S106, it is determined whether the front buffer 220 is empty. If so, the video is written in the front buffer 220a. If the back buffer 220b is not full, the video is written in the back buffer 220b in operation 5104.

In operation S108, it is determined whether a video play program has been executed in the user terminal 300. If the video play program has been executed, the corresponding video is played in operation S109. In operation S110, it is determined whether the video has been completely played. If the video has been completely played, in operation S111, it is determined whether a count of plays of the video is 0. If the count of plays of the video is 0, a remaining count of plays of the video is decreased by one in operation S112. In operation S113, the played video is stored in the queuing unit 210. In operation S114, it is determined whether a next video to be played exists in the queuing unit 210. If there is no video to be played, the procedure is finished. If a video to be played exists in the queuing unit 210, the procedure returns to operation S103.

Here, the queuing unit 210 is used to decrease the number of repetitive writing of a once-read video when the video requested from different user's terminals has to enter a playlist again. As described above, the remaining count of plays of a video is decreased whenever the video is stored in the queuing unit 210. If a video retrieved by a new user exists in the search list, the count of plays of the video increases by 1.

On the other hand, the video service information combination server may include a video play program downloader for downloading a video play program. When there is no program for analyzing information received from the user's terminal 300 and playing a video file, the video play program downloader may allow the user's terminal 300 to download the play program. In the case of an on-line desktop PC environment, the play program may be provided in a browser in a form of built-in without a separate installation process unlike a program using an existing active-X technology. Thus, the play program may freely operate regardless of the type and version of operating system. Also, in the case of a mobile environment using wireless Internet, the play program may be provided in a form of application that is optimized in a corresponding smartphone.

According to an embodiment of the present invention, different videos provided through different streaming methods can be played in any user's terminal without a separate editing.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An index-based video play apparatus for playing videos using double buffering scheme by combining pieces of video-related information transmitted from one or more video service servers in a video service information combination server and transmitting the combined video-related information to a user's terminal, the apparatus comprising:
a plurality of queuing units classifying and storing the combined video-related information transmitted from the video service servers;
a plurality of buffering units comprising a front buffer for buffering a current video data being played and a back buffer for buffering a next video data waiting in the queuing unit to be played; and
a control switching unit creating an ordered pair for the video data provided from the front buffer to transmit to the user's terminal,
wherein the number of the queuing units and the buffering units is a largest number among numbers of videos that are obtained by excluding duplication of the videos in order.

2. The apparatus of claim 1, wherein the back buffer is continuously written with a next video to be played while a video of the front buffer is being played.

3. The apparatus of claim 1, wherein the control switching unit creates an order pair of current videos to be produced and at the same time an ordered pair of next videos to be played using multi-thread.

4. An index-based video play method for playing videos using double buffering scheme by combining pieces of video-related information transmitted from one or more video service servers in a video service information combination server and transmitting the combined video-related information to a user's terminal, the method comprising:
classifying and storing, by a queuing unit of the video service information combination server, the combined video-related information transmitted from the video service servers;
buffering, by a front buffer of a buffering unit of the service information combination server, a current video data being played;
buffering, by a back buffer of the buffering unit of the service information combination server, a next video data waiting in the queuing unit to be played; and
creating, a control switching unit of the service information combination server, an ordered pair for the video data provided from the front buffer to transmit to the user's terminal,
wherein the number of the queuing units and the buffering units is a largest number among numbers of videos that are obtained by excluding duplication of the videos in order.

5. The apparatus of claim 4, wherein the back buffer is continuously written with a next video to be played while a video of the front buffer is being played.

6. The apparatus of claim 4, wherein the control switching unit creates an order pair of current videos to be produced and at the same time an ordered pair of next videos to be played using multi-thread.
